(19) United States
(12) Patent Application Publication
(10) Pub. No.: US 2015/0217700 A1
(43) Pub. Date: Aug. 6, 2015

(54) Clamp Device For Securing A Load To A Vehicle Mounted Load Bar

(71) Applicants: Joseph R. FLAHERTY, Prospect, CT (US); THULE SWEDEN AB, Hillerstorp (SE)

(72) Inventor: Joseph Flaherty, Prospect, CT (US)

(21) Appl. No.: 14/427,291

(22) PCT Filed: Jul. 26, 2013
(86) PCT No.: PCT/US13/52421

§ 371 Date: Mar. 10, 2015

Related U.S. Application Data
(60) Provisional application No. 61/699,804, filed on Sep. 11, 2012.

(51) Int. Cl. B60R 11/00; F16B 2/06; B60R 9/10

(52) U.S. Cl. CPC B60R 11/00; B60R 9/10; F16B 2/065; B60R 2011/0059; B60R 2011/0084

(57) ABSTRACT

A clamp device for securing a load to a vehicular mounted load bar is disclosed. The clamp device can include an upper bracket coupled to a lower bracket by spaced apart fasteners. Each bracket can have a load bar engaging surface. The lower bracket can have a pivot end with a closed elongate slot and an opposite swing end having an open elongate slot. A pivot fastener can interconnect the upper bracket to the pivot end of the lower bracket. The pivot fastener can protrude and be trapped within the closed elongate slot. A freeable fastener can releasably interconnect the upper bracket to the swing end of the lower bracket. The freeable fastener can be retracted into and protrudes through the open elongate slot in the lower bracket in a restrained configuration in which the freeable fastener can be positioned between opposite lateral sides of the open elongate slot.

### CROSS-REFERENCE TO RELATED APPLICATION

This application claims priority to U.S. Provisional Application No. 61/699,804, filed Sep. 11, 2012, the contents of which are entirely incorporated by reference herein.

### FIELD

The present disclosure relates generally to load carriers. More specifically, embodiments within this disclosure relate to a mechanism configured to clamp the load carrier to a vehicular mounted load bar.

### BACKGROUND

Safely and conveniently transporting sports equipment is a concern for many sports enthusiasts. For example, bicycles can be carried on bicycle carriers. Typically, the carrier can be a hitch mounted carrier, a carrier configured to be coupled to the rear of the vehicle, or a carrier configured to be coupled to a rack on the roof of the vehicle.

### BRIEF DESCRIPTION OF THE DRAWINGS

Implementations of the present application will now be described, by way of example only, with reference to the attached figures, wherein:

FIG. 1 is a perspective view of a load carrier, in accordance with an exemplary embodiment, mounted to an exemplarily roof rack of a vehicle;

FIG. 2 is a perspective view of the load carrier of FIG. 1, in accordance with an exemplary embodiment;

FIG. 3 is a perspective view of a clamp device in accordance with an exemplary embodiment;

FIG. 3A is a perspective view of a portion of the clamp device of FIG. 3;

FIG. 3B is a perspective view of a portion of the clamp device of FIG. 3;

FIG. 3C is a perspective view of a clamp device with an alternative compressible channel insert, in accordance with an exemplary embodiment;

FIG. 3D is a perspective view of a clamp device with an alternative compressible channel insert, in accordance with an exemplary embodiment;

FIG. 4 is an elevation view of a clamped configuration of a clamp device, in accordance with an exemplary embodiment;

FIG. 5 is an elevation view of a loosened configuration of a clamp device, in accordance with an exemplary embodiment;

FIG. 6 is a plan view of an open configuration of a clamp device, in accordance with an exemplary embodiment;

FIG. 7 is an elevation view of a clamp device having friction fit attachment inserted into a channel of a load bar, in accordance with an exemplary embodiment;

FIG. 8 is an end view of a load bar having a channel formed therein, in accordance with an exemplary embodiment;

FIG. 9 is an elevation view of a compressible channel insert in an expanded configuration, in accordance with an exemplary embodiment;

FIG. 10 is an elevation view of a compressible channel insert in a compressed configuration, in accordance with an exemplary embodiment;

FIG. 11 is an elevation view of an alternative compressible channel insert in a compressed configuration, in accordance with an exemplary embodiment;

FIG. 12 is a perspective view of a clamp device with an alternative compressible channel insert, in accordance with an exemplary embodiment;

FIG. 13 is a perspective view of a clamp device with an alternative compressible channel insert, in accordance with an exemplary embodiment; and

FIG. 14 is a perspective view of a clamp device with an alternative compressible channel insert, in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures and components have not been described in detail so as not to obscure the related relevant function being described. Also, the description is not to be considered as limiting the scope of the implementations described herein. Descriptions and characterizations of embodiments herein are not to mutually exclusive.

The present disclosure concerns a clamp device for securing a load to a vehicular mounted load bar. The clamp device can include an upper bracket. The upper bracket can be coupled to a lower bracket by spaced apart fasteners. Each bracket can have a load bar engaging surface that faces the other in a clamped configuration of the clamp device when clamp-secured about the load bar. The lower bracket can have a pivot end with a closed elongate slot extending there-through. The lower bracket can also have an opposite swing end having an open elongate slot extending there-into. Each elongate slot can have a long-axis substantially parallel to one another. The clamp device can further include a pivot fastener. The pivot fastener can interconnect the upper bracket to the pivot end of the lower bracket. The pivot fastener can protrude through, and can be trapped within the closed elongate slot in the lower bracket. The clamp device can further include a freeable fastener. The freeable fastener can releasably interconnect the upper bracket to the swing end of the lower bracket. The freeable fastener can be retracted into and protrude through the open elongate slot in the lower bracket in a restrained configuration in which the freeable fastener can be positioned between opposite lateral sides of the open elongate slot. In a freed configuration, the freeable fastener can be withdrawn outside the open elongate slot thereby permitting the swing end of the lower bracket to pivot about the pivot fastener trapped in the closed elongate slot of the lower bracket.

Additionally, the present disclosure can concern a clamp device member including a load carrier engaging portion is presented. The load carrier engaging portion frictionally, releasably secures the clamp device member to a component of a load carrier at continuous variable positions along a length of an elongate channel defined within the load carrier component. The length of channel can have a substantially uniform cross-sectional shape and size. The load carrier engaging portion can include a compressible channel insert that is biased toward an expanded configuration. The compressible channel insert can be coupled to a rack engaging portion of the clamp device member. The compressible channel insert can assume the expanded configuration when outside the channel of the load carrier component and can assume a compressed configuration when installed within the channel of the load carrier component.

The clamp device can be implemented with or without the load carrier portion having a compressible channel insert. The clamp device can optionally include one or more of the features presented herein.

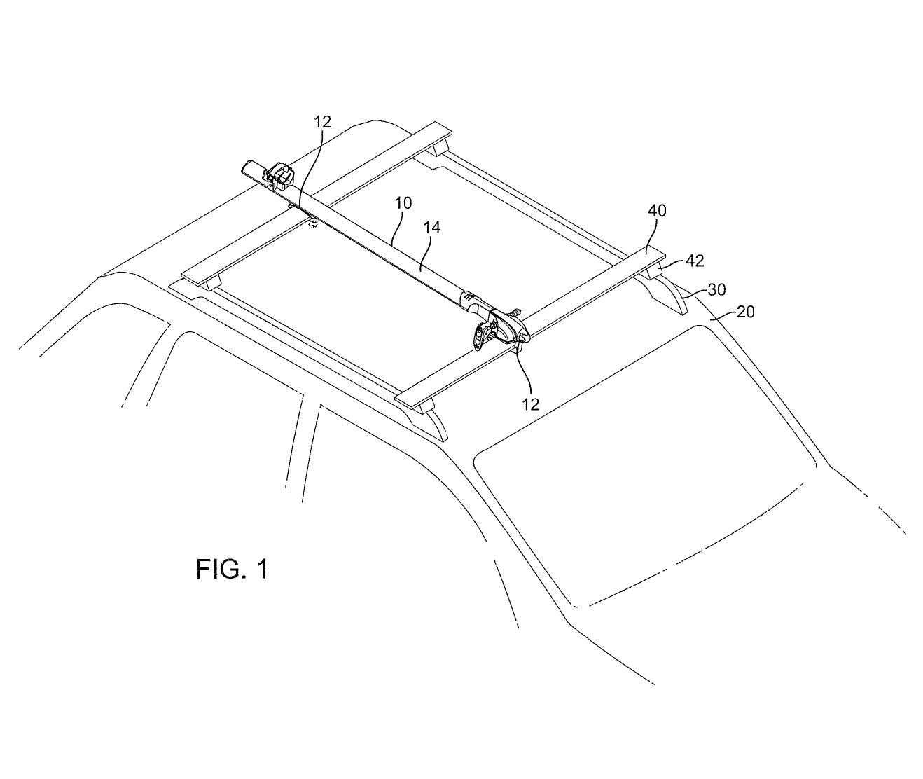

Referring to FIG. 1, an example of a load carrier 10 is illustrated. The load carrier 10 can be coupled to the vehicle 20 through one or more rack components. As illustrated, the load carrier 10 is coupled to a cross member or load bar 40 that runs the width of the vehicle 20 by a pair of coupling feet 12. The coupling feet 12 can have various shapes and configurations depending on the cross member or load bar 40 and load carrier 10. The cross member or load bar 40 is in turn coupled to the roof rack 30 by cross member rack feet 42. The cross member rack feet 42 can have various sizes and configurations to allow for the coupling of the cross member or load bar 40 to the roof rack 30. In the illustrated embodiment, the roof rack 30 is coupled directly to the vehicle 20. In other embodiments, the cross member or load bar 40 can be formed together with the roof rack 30 so that no cross member rack feet 42 are required. In some embodiments, the cross member or load bar 40 can be fixedly coupled to the roof rack 30 with fasteners.

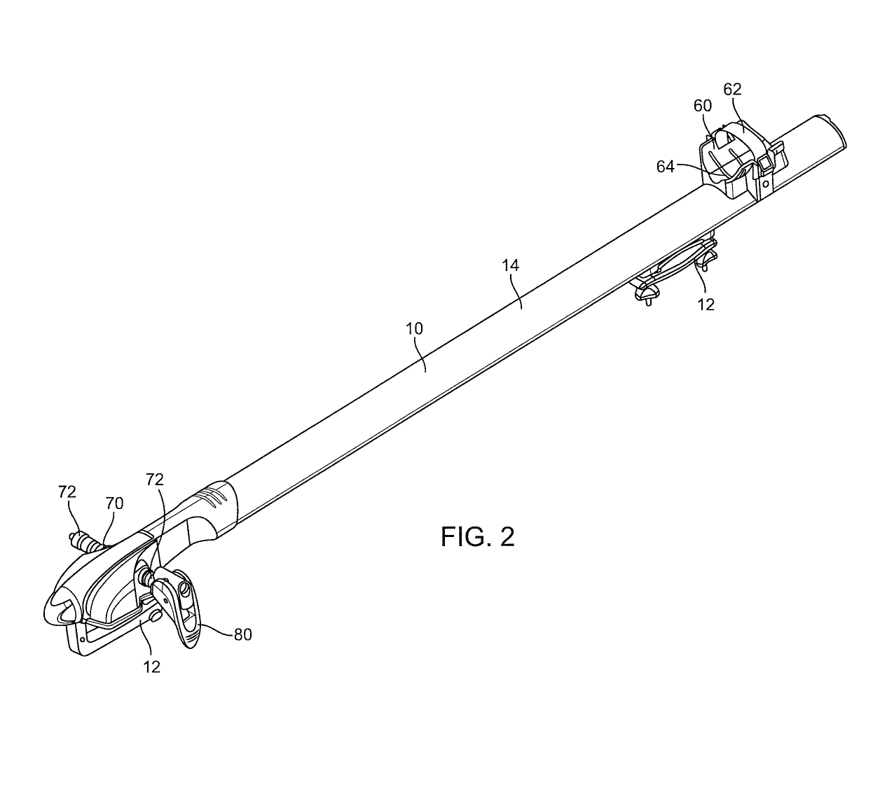

FIG. 2 illustrates a more detailed example of the load carrier 10 that is illustrated in FIG. 1. The load carrier 10 can be coupled to coupling feet 12. In at least one embodiment, the load carrier 10 can also include bicycle fork anchor 50 and a rear wheel tray 60. The rear wheel tray 60 includes a wheel receiving portion 64 and retaining strap 62. The wheel receiving portion 64 can be configured based on the type of bicycle to be mounted thereon. For example, in at least one embodiment, different wheel trays 60 can be available for mountain bicycles, road-bicycles, or speed trial bicycles, among other types of wheels and frames. In yet other embodiments, such as the one illustrated, the bicycle tray 60 can include a wheel receiving portion 64 that can accommodate two or more types of bicycle tires or rims. The strap 62 as illustrated is an adjustable strap. As illustrated, the load carrier 10 includes a main tube or carrier component 14.

The bicycle fork anchor 50 includes an anchor body 52 which can protect the internal components from damage and/or provide a streamlined shape. The bicycle fork anchor 50 also includes a skewer 70. The skewer 70 is configured to releasably couple a bicycle fork to the bicycle fork anchor 50. The skewer 70 has two heads 72. The movement of the skewer heads 72 can be controlled by rotating the manually operable actuator 80. In other embodiments, the load carrier can be configured to carry skis, snow boards, or cargo containers. The present technology in the form of a clamp device can be implemented as one or both of the load carrier feet 12.

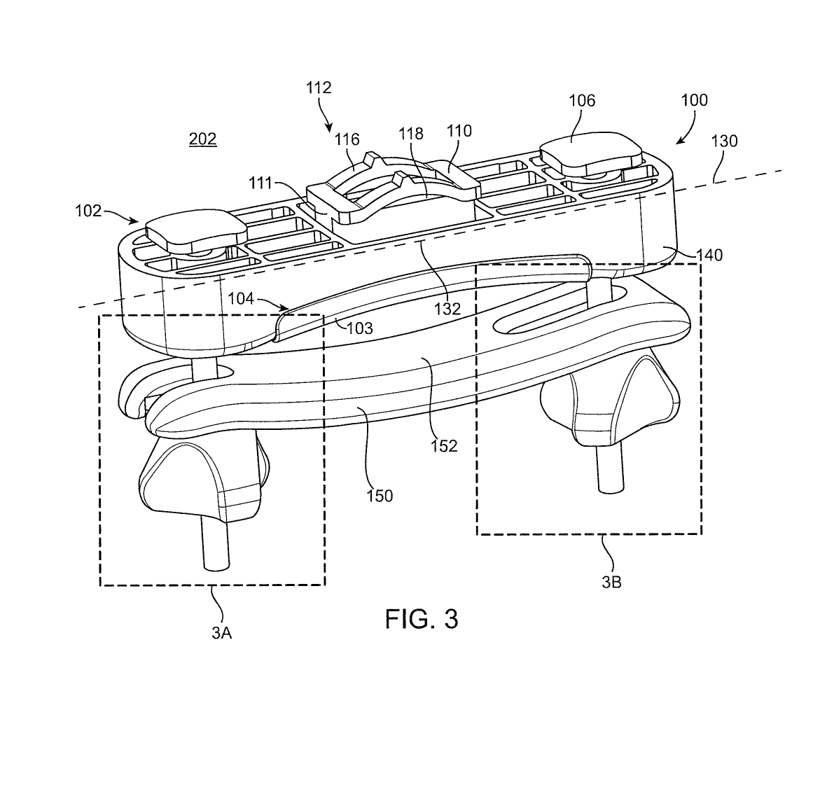

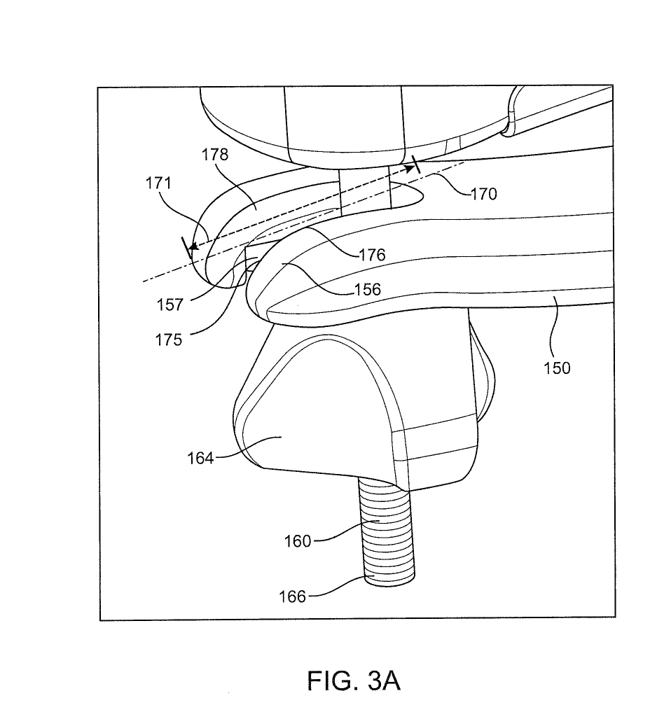

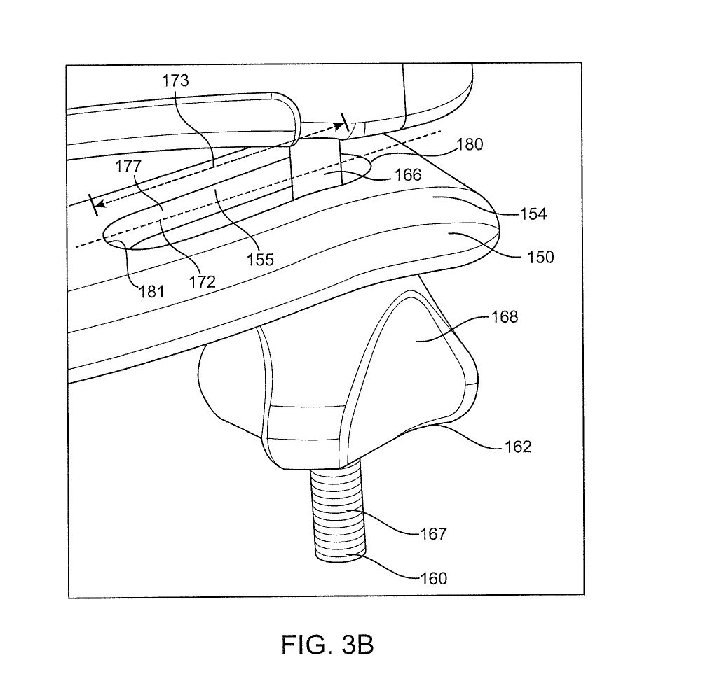

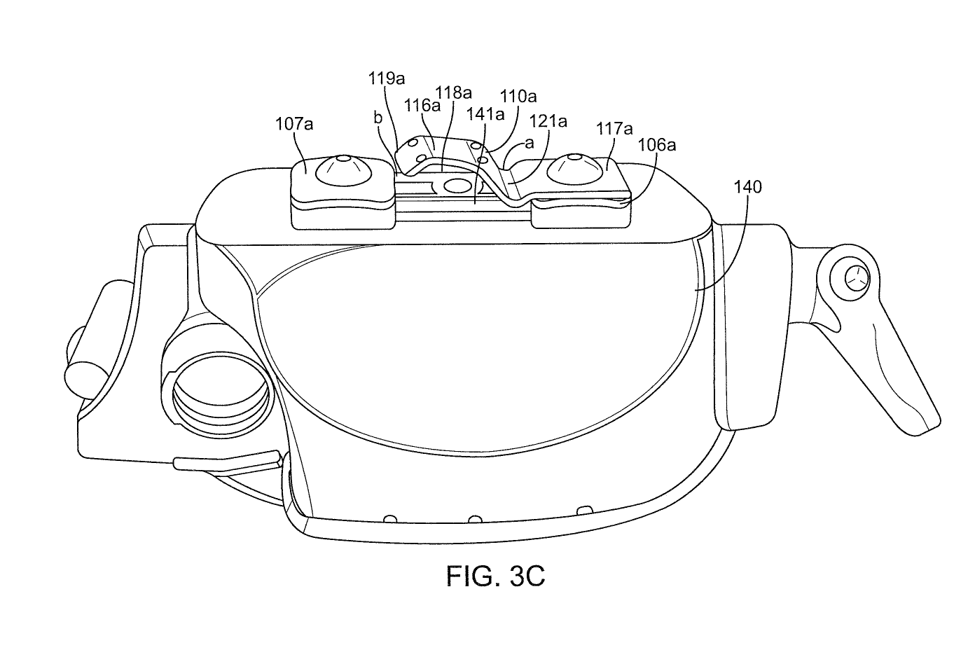

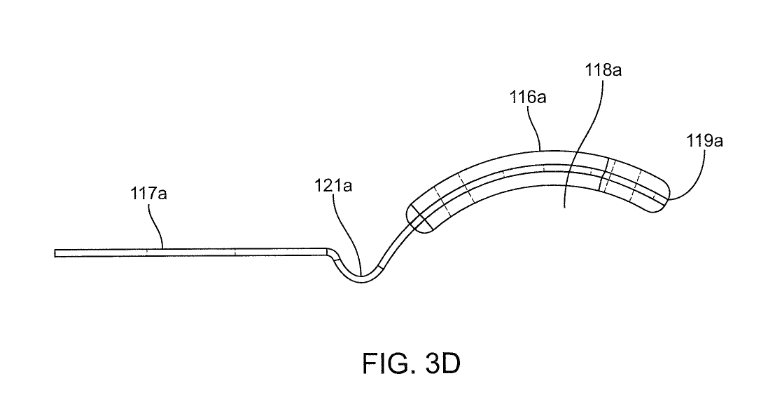

FIG. 3 is a perspective view of a clamp device 100, in accordance with an exemplary embodiment. As indicated above, in at least one embodiment, the load carrier engaging portion 102 can include a compressible channel insert 110. In other embodiments, the load carrier engaging portion 102 does not include the compressible channel insert 110. When the compressible channel insert 110 is included, the compressible channel insert 110 can be biased toward an expanded configuration 112. When the compressible channel insert 110 is biased toward the expanded configuration 112, the positioning of the clamp device 100 along a load carrier component can be enhanced as it prevents sliding along the channel. This provides enhanced positioning because the user can move the clamp device 100 to a desired location along the channel without the clamp device 100 have to be loosened or tightened repeatedly.

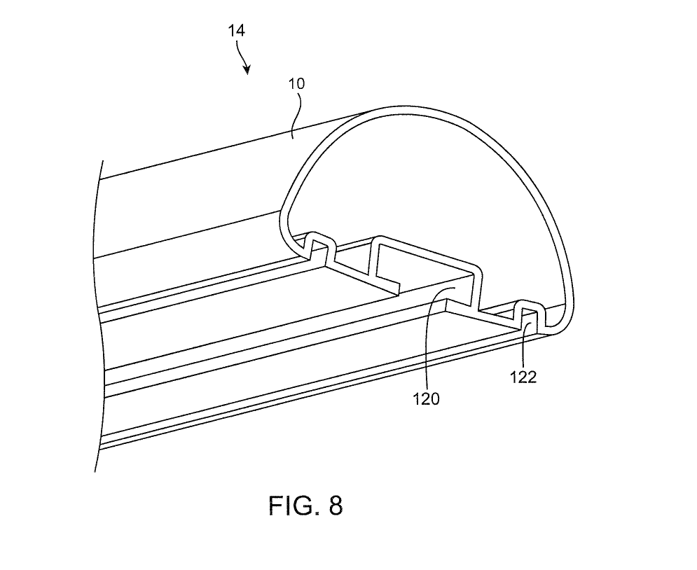

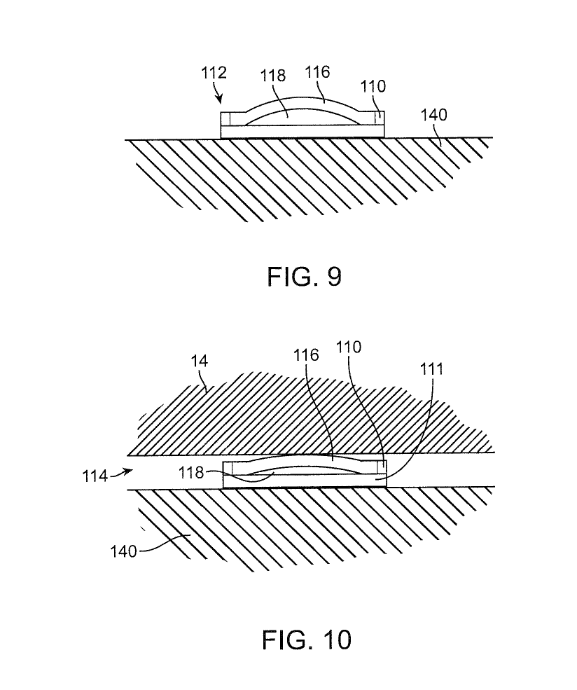

The compressible channel insert 110 can be coupled to the upper bracket 140. The compressible channel insert 110 can assume the expanded configuration 112 when outside the channel 120 of the load carrier component 14 and assumes a compressed configuration 114 when installed within the channel 120 of the load carrier component 14 (see FIGS. 9 and 10). The compressible channel insert 110 can be coupled to the upper bracket 140 by a necked, through-slot extension 111. In at least one embodiment, the compressible channel insert 110 and the necked, through-slot extension 111 can be monolithic. In other embodiments, the channel insert 110 and the necked, through-slot extension 111 can be formed separately and fastened to one another. In yet other embodiments, the channel insert 110 and the necked, through-slot extension 111 can be formed separately and bonded to one another. In yet another embodiment, the compressible channel insert 110, the necked, through-slot extension 111 and the upper bracket 140 can be monolithic. In still other embodiments, the compressible channel insert 110, the necked, through-slot extension 111 and the upper bracket 140 can be formed separately and bonded together. In yet other embodiments, the compressible channel insert 110, the necked, through-slot extension 111 and the upper bracket 140 can be formed separately and fastened together.

The compressible channel insert 110 can include a spring portion 116 biased toward the expanded configuration 112. The spring portion 116 can be formed separately from the remainder of the compressible channel insert 110 or can be formed together with the compressible channel insert 110. In at least one embodiment, the spring portion 116 can be constructed from plastic that is flexible enough to be compressed from the expanded configuration 112 to the compressed configuration 114. In yet other embodiments, the spring portion 116 can be metallic such that the spring portion is in the elastic region between the expanded configuration 112 and the compressed configuration 114.

An open gap space 118 can at least partially surround the spring portion 116 in the expanded configuration 112. The spring portion 116 can collapse at least partially into the open gap space 118 in the compressed configuration 114.

The compressible channel insert 110 can be coupled to the upper bracket 140 midway 132 along a length-wise axis 130 of the upper bracket 140. A load bar engaging surface layer 103 on the upper bracket 140 can be opposite to the compressible channel insert 110. The load bar engaging surface layer 103 can constructed from a different material than the upper bracket 140. For example, the load bar engaging surface layer 103 can be constructed from a slip-resistant material that is softer than the material that constructs the upper bracket 140. When the load bar engaging surface layer 103 is of a softer material than the upper bracket 140, the softer material can provide for a cushioning effect so as to reduce the shock felt by the load carrier 10. By having a harder material for the upper bracket 140, strength and rigidity can be maintained while at the same time allowing for a dampening feature.

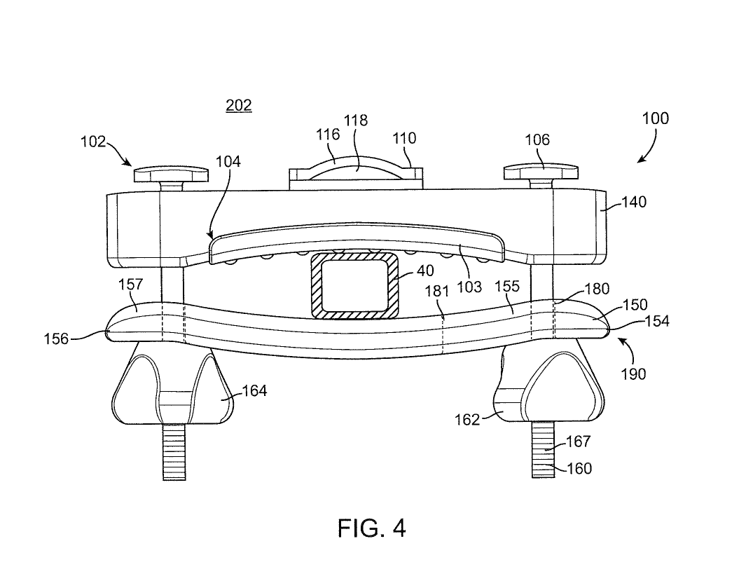

In the illustrated embodiment of FIG. 3, the spring portion 116 can be peak shaped. In other embodiments, such as those shown in FIGS. 4-7 and 9-10, the spring portion 116 is dome shaped. When the spring portion 116 is peak shaped, the spring portion 116 can provide for enhanced positioning force as compared to a domed shaped spring portion 116. In other embodiments, the spring portion 116 can take other shapes as well. An open gap space 118 can at least partially surround the peak-shaped spring portion 116 in the expanded configuration 112. The peak-shaped spring portion 116 can collapse at least partially into the open gap space 118 in the compressed configuration 114. In at least one embodiment, the peak-shaped spring portion 116 can be constructed from plastic that is manually flexible in the expanded configuration 112. In other embodiments, the peak-shaped spring portion 116 can be constructed from metal that operates in the elastic deformation region from the expanded configuration 112 to the compressed configuration 114.

In other embodiments, the spring portion can be a partial peak. In such examples, where instead of forming a full peak in which each end contacts a surface, one of the ends of the peak is suspended a distance above a surface forming a partial or semi arch. For example, FIG. 3C and FIG. 3D illustrate alternative compressible channel insert 110a. The compressible channel insert 110a includes partial peak-shaped spring portion 116a. In this shape, the partial peak-shaped spring 116a begins at point a near first tab 106a in contact with the top surface mount 141a of upper bracket 140. The partial peak-shaped spring 116a then arches between tabs 106a and 107a, yet terminates at distal end 119a prior to reaching point b near tab 107a, and is therefore resiliently suspended a distance above the surface.

The compressible channel insert 110a can be coupled to the upper bracket 140. In some embodiments, the compressible channel insert 110a and the upper bracket 140 can be monolithic. In the embodiment shown, in FIG. 3C, they are shown as separate pieces. For example, in that figure the compressible channel insert 110a is comprised of the partial peak-shaped spring portion 116a, as well as a planar portion 117a, each connected by a lip 121a. The planar portion 117a is a flat planar extension with an aperture for receiving fastener 160a there-through. In the embodiment shown, the planar portion 117a is laid flat between the head 161a of the fastener 160a and the top of the tab 106a. In other embodiments the planar portion 117a can be between the tab 107a and the top surface mount 141a or top surface of the upper bracket 140. In other embodiments the planar portion 117a can be monolithic with the upper bracket 140. In still other embodiments, there need not be a planar portion 117a, and the partial peak-shaped spring portion 116a can merely extend from the top surface mount 141a or top surface of the upper bracket 140.

As further shown in FIG. 3C, a lip 121a connects the planar portion 117a to the partial peak-shaped spring portion 116a. The lip 121a steps downward from the planar portion 117a to the top surface mount 141a and serves to provide a base for the partial peak-shaped spring portion 116a. The partial peak-shaped spring portion 116a arches from tab 106a toward tab 107a, however, the spring portion 116a terminates prior to reaching the tab 107a and thus extends a distance above top surface mount 141a.

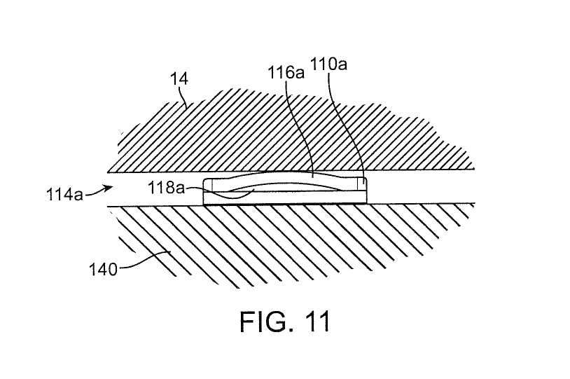

An open gap space 118a can at least partially surround the spring portion 116a in the expanded configuration 112a. The partial peak-shaped spring portion 116a can collapse at least partially into the open gap space 118a in the compressed configuration 114a. As the distal end 119a extends above top surface mount 141a, when collapsed, the distal end 119a may move closer to the top surface mount 141a, and in some embodiments may in fact contact the top surface mount 141a (as shown in FIG. 11). In still further embodiments, in addition to the distal end contacting the top surface mount 141a, the arch of partial peak 116a may collapse and flatten to a degree similar to peak 116 in FIG. 10 (as shown in FIG. 11). The degree of collapse depends on the size of the channel into which the channel insert 110a is placed.

The partial peak-shaped spring portion 116a can be made of similar material, flexibility and resiliency as peak 116. In at least one embodiment, the peak-shaped spring portion 116a can be constructed from plastic that is manually flexible in the expanded configuration 112a. In other embodiments, the peak-shaped spring portion 116a can be constructed from metal that operates in the elastic deformation region from the expanded configuration 112a to the compressed configuration 114a.

FIGS. 3A and 3B are provided to illustrated detailed views of a lower bracket 150 of the clamp device, specifically, a closed elongate slot 155 and an open elongate slot of the lower bracket 150.

The clamp device 100 as illustrated can be implemented to secure a load to a vehicular mounted load bar (not shown). The clamp device 100 can include an upper bracket 140. The upper bracket 140 of the clamp device 100 can be coupled to a lower bracket 150 by spaced apart fasteners 160. Each bracket (140, 150) can have a load bar engaging surface (104, 152) that faces the other in a clamped configuration 202 of the clamp device 100, when clamp-secured about the load bar (not shown). The lower bracket 150 can have a pivot end 154 with a closed elongate slot 155 extending there-through and an opposite swing end 156 having an open elongate slot 157 extending there-into. Each elongate slot (155, 157) can have a long-axis (170, 172) substantially parallel to one another. A pivot fastener 162 can interconnect the upper bracket 140 to the pivot end 154 of the lower bracket 150. The pivot fastener 162 can protrude through, and can be trapped within the closed elongate slot 155 in the lower bracket 150. A freeable fastener 164 can releasably interconnect the upper bracket 140 to the swing end 156 of the lower bracket 150. The freeable fastener 164 can be retracted into and protrudes through the open elongate slot 157 in the lower bracket 150 in a restrained configuration 190 in which the freeable fastener 164 is positioned between opposite lateral sides (176, 178) of the open elongate slot 157.

In a freed configuration, the freeable fastener 164 can be withdrawn outside the open elongate slot 157 thereby permitting the swing end 156 of the lower bracket 150 to pivot about the pivot fastener 162 trapped in the closed elongate slot 155 of the lower bracket 150. An example of a freed configuration will be further described below in relation to FIG. 5.

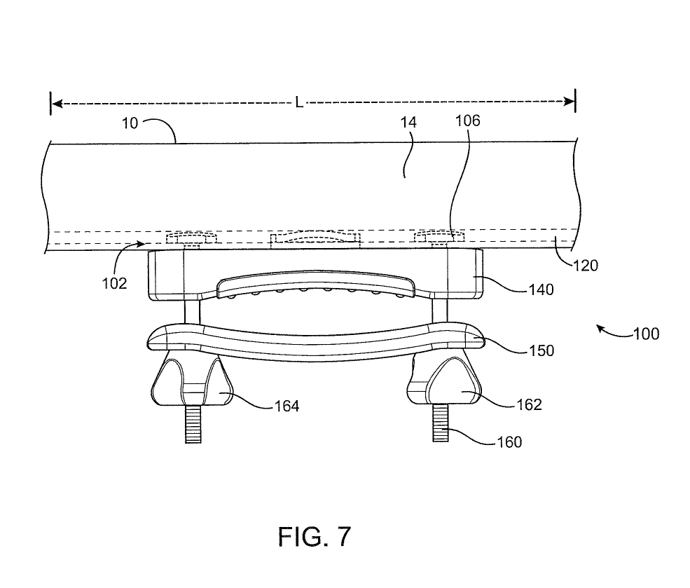

Each of the pivot fastener 162 and freeable fastener 164 can include a tab 106 that is part of the load carrier engaging portion of the clamp device 100. The tab 106 allows for the fasteners 162, 164 to slide in a channel 120 and to be tightened relative to the channel 120. This is further illustrated with respect to FIG. 7 below.

Turning to FIGS. 3A and 3B, a length 173 of an open space 177 defined within the closed elongate slot 155 can be greater than a length 171 of an open space 175 defined between the lateral sides 176, 178 of the open elongate slot 157. When the length 173 of the closed elongate slot 155 is greater than the length 171 of the open elongate slot 157, transition from the restrained configuration 190 (see FIG. 4) in which the freeable fastener 164 is positioned within the open elongate slot 157 to the freed configuration 192 (see FIG. 5) in which the freeable fastener 164 is outside the open elongate slot 157 can be achieved. The pivot fastener 162 can be positioned in a distal end portion 180 of the closed elongate slot 155 located distally from the open elongate slot 157 when the freeable fastener 164 is in the restrained configuration 190. The pivot fastener 162 can be positioned in a proximal end portion 181 of the closed elongate slot 155 located proximate to the open elongate slot 157 when the freeable fastener 164 is in the freed configuration 192.

In at least one embodiment, at least one of the spaced apart fasteners 160 can be a bolt 166 having a threaded portion 167 positioned proximate the lower bracket 150 in the restrained configuration 190. Furthermore, a manually engageable nut 168 can be threadedly engaged upon the threaded portion 167 of the bolt 166.

FIG. 4 illustrates an elevation view of a clamped configuration 202 of a clamp device 100, in accordance with an exemplary embodiment. As illustrated, the clamping device 100 has an upper bracket 140 and a lower bracket 150. The clamp device 100 is shown in clamped configuration 202. In the clamped configuration 202, the clamp device 100 is clamped around the load bar 40. The upper bracket 140 includes a load bar engaging surface 104. The load bar engaging surface can further include a load bar engaging surface layer 103, which can be a different material than the upper bracket 140. As described above, the load bar engaging surface layer 103 can be made of a softer material. Additionally, as illustrated, the load bar engaging surface layer 103 can include a plurality of ridges or protrusions that are further configured to grip the load bar 40.

Furthermore, in the clamped configuration 202, the lower bracket 150 can be in the constrained configuration 190. In the constrained configuration 190, the pivot fastener is positioned in a distal end portion 180 of the closed elongate slot 155. Additionally, the freeable fastener 164 is located within the open elongate slot 157. As illustrated, the pivot fastener 162 and freeable fastener 164 are both located between the pivot end of the lower bracket 150 and the opposite swing end 156 of the lower bracket 150.

FIG. 4 also illustrates the optional compressible channel insert 110 on the load carrier engaging portion of the upper bracket 140. The compressible channel insert 110 includes a spring portion 116 and an open gap space 118 beneath the spring portion 116. As indicated above, the spring portion 116 is dome shaped. In other embodiments, the spring portion 116 can take other shapes such as peak-shape described above.

FIG. 5 is an elevation view of a loosened configuration 204 of a clamp device, in accordance with an exemplary embodiment. In the loosened configuration 204, the lower bracket 150 can be in the freed configuration 192. In the freed configuration 192, the lower bracket has moved to the right relative to FIG. 4. As illustrated, the pivot fastener 162 is positioned such that it is near the proximal end portion 181 of the closed elongate slot 155. When the pivot fastener 162 is located near the proximal end portion 181 of the closed elongate slot 155, the opposite swing end 156 of the lower bracket 150 is located between the pivot fastener 162 and the freeable fastener 164, such that the opposite swing end 156 is not constrained and the lower bracket 150 can pivot about the pivot fastener 162.

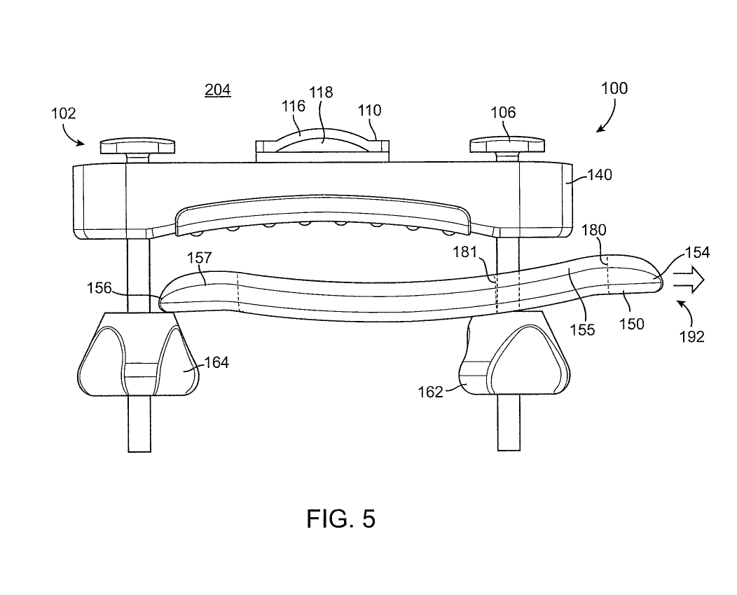

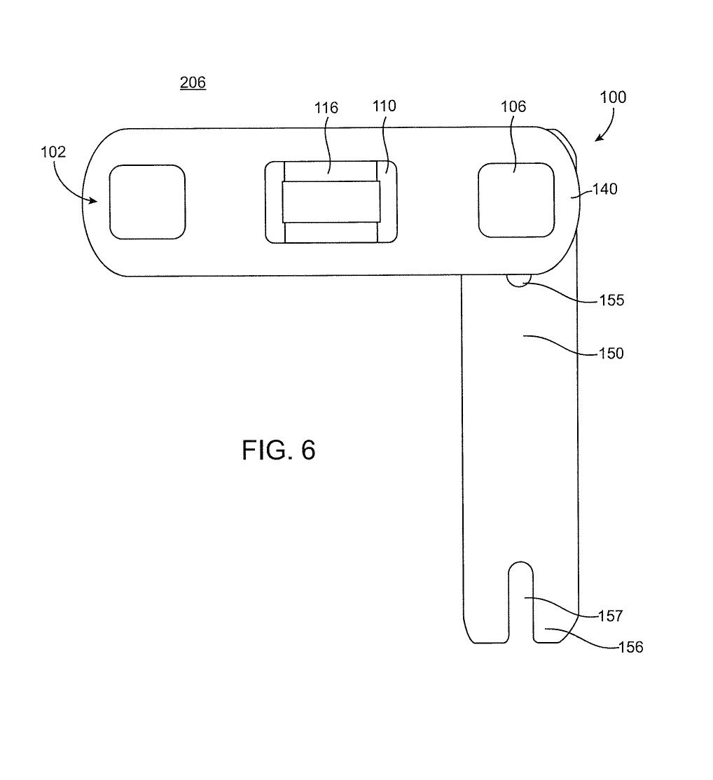

FIG. 6 is a plan view of an open configuration 206 of a clamp device 100, in accordance with an exemplary embodiment. FIG. 6 illustrates the pivoting of the lower bracket 150 about the pivot fastener 162 as compared to the orientation of the lower bracket in FIG. 5. As shown, the lower bracket 150 has been pivoted. In the open configuration 206, the clamp device 100 can be removed from the load bar 40.

When the clamp device 100 is capable of having the clamped configuration 202, loosened configuration 204, and open configuration 206 as illustrated in FIGS. 4-6, the clamp device 100 can be more easily removed from the load bar 40. In other implementations of clamp devices, the fasteners would have to be substantially loosened and at least one loosened completely to allow for removal of the clamp device from around the load bar 40. The presently disclosed clamp device 100 requires less loosening and does not require one fastener to be completely loosened. This allows for the user to save time in installing the clamp device 100 to a load bar 40. Furthermore, when the lower bracket 140 pivots, the lower bracket 140 can be retained thereby preventing loss. Additionally, by allowing the fasteners 162, 164 to at least remain together with their respective nuts 168, it reduces the chance of losing a nut or accidentally dropping a nut and scratching the paint of the vehicle.

FIG. 7 is an elevation view of a clamp device 100 having friction fit attachment inserted into a channel 120 of a load carrier 10, in accordance with an exemplary embodiment. As illustrated, the upper bracket 140 can include a load carrier engaging portion 102 that frictionally, releasably secures the upper bracket 140 to a component 14 of a load carrier 10 at continuous variable positions along a length L of an elongate channel 120 defined within the load carrier component 14, wherein the length L of channel 120 has a substantially uniform cross-sectional shape and size.

FIG. 8 is an end view of a load carrier component 14 having a channel 120 formed therein, in accordance with an exemplary embodiment. As illustrated the load carrier component 14 has a substantially uniform cross-sectional shape and size. Additionally, side channels 122 are formed in the load carrier component 14. The side channels 122 can be added for weight saving or strengthening of the load carrier component 14. In other embodiments, the load carrier engaging portion 102 of the clamp device 100 can be configured to have components that are designed to engage with the side channels 122. In other embodiments, other structures can be formed in the load carrier component 14. When the other structures are formed therein, the load carrier engaging portion 102 can be configured to be coupled thereto. Additionally, the load carrier component 14 can have a portion that is attached and extends therefrom for engagement with the load carrier engaging portion 102.

FIG. 9 illustrates an elevation view of a compressible channel insert 110 in an expanded configuration 112, in accordance with an exemplary embodiment. FIG. 10 is an elevation view of a compressible channel insert 110 in a compressed configuration 114, in accordance with an exemplary embodiment. As shown in FIG. 9, the compressible channel insert 110 is not installed in a channel. As illustrated, the compressible channel insert 110 is biased to an expanded configuration 112. In the expanded configuration 112, the spring portion 116 is fully extended and gap space 118 surrounds the spring portion. The compressible channel insert 110 in FIG. 9, is illustrated as being coupled to the upper bracket 140. FIG. 10 illustrates the compressible channel insert 110 in a compressed configuration 114, once the compressible channel insert 110 has been placed in a channel 120 of the load carrier component 14. As illustrated, the spring component 116 has been compressed relative to the position in FIG. 9, such that the amount of gap space 118 is reduced compared to FIG. 9. Thus, the compressible channel insert 110 can provide for an enhanced friction resistance so that the upper bracket 140 does not slide as easily relative to the load carrier component 14. This provides for enhanced positioning of the clamp device 100 relative to the load carrier component 14.

FIG. 3C illustrates an elevational view of an alternative compressible channel insert 110a, not installed in a channel such as the channel 120 in FIG. 8. FIG. 11 illustrates the alternative compressible channel insert 110a in a compressed configuration 114a, once the alternative compressible channel insert 110a has been placed in a channel 120, shown in FIG. 8, of the load carrier component 14. As illustrated, the partial spring component 116a has been compressed relative to the position in FIG. 3C, such that the amount of gap space 118a is reduced compared to FIG. 3C. The partial spring component 116a frictionally presses against the upper surface of the channel 120. The enhanced friction resistance is such that the upper bracket 140 does not slide as easily relative to the load carrier component 14.

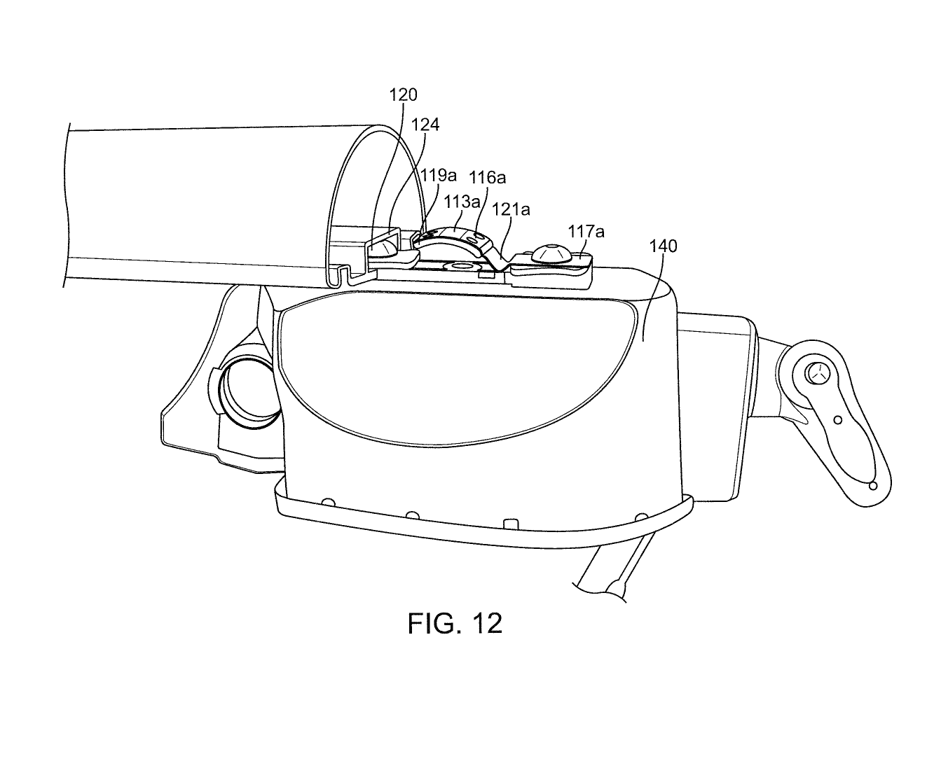

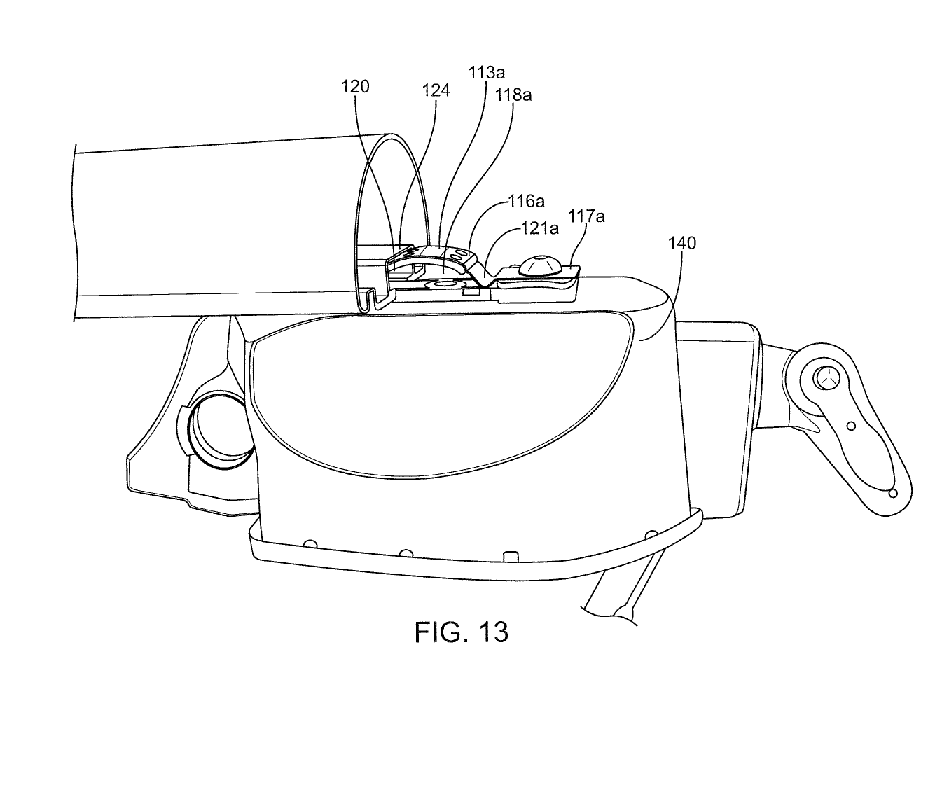

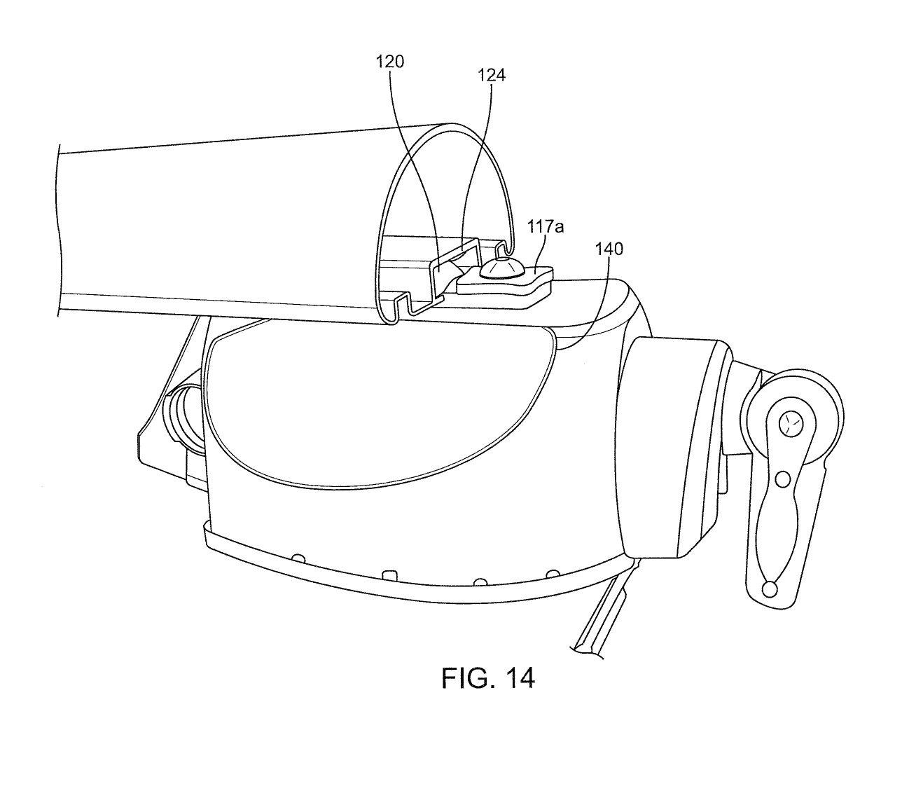

The insertion of alternative compressible channel insert 110a into channel 120 is illustrated in FIGS. 12-14. FIG. 12 illustrates the alternative channel insert 110a just prior to insertion into channel 120. FIG. 13 illustrates alternative channel insert 110a upon initial entry into channel 120. Notably, in the exemplary embodiment shown in FIG. 12, the distal end 119a of the partial spring component 116a terminates just below the top edge 124 of the channel 120. Accordingly, the distal end will not catch on the edge 124 but permits insertion into the channel 120. Moreover, although the distal end 119a is just below the edge 124, the crest 113a of the arch is just above the edge 124, and thus engages the edge 124 and is forced downward as it is inserted into the channel 120. FIG. 13 illustrates the alternative channel insert 110a entered partially into the channel 120. As shown therein, the crest 113a engages the edge during insertion of the alternative channel insert 110a. The upward bias of the partial spring component 116a creates enhanced friction resistance so that the upper bracket 140 does not slide as easily relative to the load carrier component 14. Once fully inserted, as shown in FIG. 14, the alternative compressible channel insert 110a has the compressed configuration 114a as shown in FIG. 11. Although in FIG. 11, the distal end of the channel insert 110a contacts the top surface when compressed, in other embodiments it may hang suspended above the top surface, an in still other embodiments it may compress to lesser or greater degree, depending on the size of the channel.

Example implementations have been described hereinabove regarding various example embodiments. The example embodiments are intended to constitute non-limiting examples. The subject matter that is intended to be within this disclosure is set forth in the following claims.

1. A clamp device for securing a load to a vehicular mounted load bar, the clamp device comprising:
an upper bracket coupled to a lower bracket by spaced apart fasteners, each bracket having a load bar engaging surface that faces the other in a clamped configuration of the clamp device when clamp-secured about the load bar, the lower bracket having a pivot end with a closed elongate slot extending there-through and an opposite swing end having an open elongate slot extending there-into, each elongate slot having a long-axis substantially parallel to one another;
a pivot fastener interconnecting the upper bracket to the pivot end of the lower bracket, wherein the pivot fastener protrudes through, and is trapped within the closed elongate slot in the lower bracket; and
a freeable fastener releasably interconnecting the upper bracket to the swing end of the lower bracket, wherein the freeable fastener is retracted into and protrudes through the open elongate slot in the lower bracket in a restrained configuration in which the freeable fastener is positioned between opposite lateral sides of the open elongate slot, and wherein in a freed configuration the freeable fastener is withdrawn outside the open elongate slot thereby permitting the swing end of the lower bracket to pivot about the pivot fastener trapped in the closed elongate slot of the lower bracket.

2. The clamp device recited in claim 1, wherein a length of an open space defined within the closed elongate slot is greater than a length of an open space defined between the lateral sides of the open elongate slot thereby permitting transition from the restrained configuration in which the freeable fastener is positioned within the open elongate slot to the freed configuration in which the freeable fastener is outside the open elongate slot.

3. The clamp device recited in claim 2, wherein the pivot fastener is positioned in a distal end portion of the closed elongate slot located distally from the open elongate slot when the freeable fastener is in the restrained configuration and the pivot fastener is positioned in a proximal end portion of the closed elongate slot located proximate to the open elongate slot when the freeable fastener is in the freed configuration.

4. The clamp device recited in claim 1, wherein at least one of the spaced apart fasteners comprises a bolt having a threaded portion positioned proximate the lower bracket in the restrained configuration.

5. The clamp device recited in claim 4, further comprising a manually engageable nut threadedly engaged upon the threaded portion of the bolt.

6. The clamp device recited in claim 1, wherein:
the upper bracket comprises a load carrier engaging portion that frictionally, releasably secures the upper bracket to a component of a load carrier at continuous variable positions along a length of an elongate channel defined within the load carrier component, wherein the length of channel has a substantially uniform cross-sectional shape and size;
the load carrier engaging portion comprises a compressible channel insert that is biased toward an expanded configuration; and
the compressible channel insert is coupled to the upper bracket, and wherein the compressible channel insert assumes the expanded configuration when outside the channel of the load carrier component and assumes a compressed configuration when installed within the channel of the load carrier component.

7. The clamp device recited in claim 6, wherein the compressible channel insert is coupled to the upper bracket by a necked, through-slot extension.

8. The clamp device recited in claim 6, wherein the compressible channel insert comprises a spring portion biased toward the expanded configuration.

9. The clamp device recited in claim 8, wherein the spring portion is peak-shaped.

10. The clamp device recited in claim 9, further comprising an open gap space surrounded at least partially by the peak-shaped spring portion in the expanded configuration, and wherein the peak-shaped spring portion collapses at least partially into the open gap space in the compressed configuration.

11. The clamp device recited in claim 10, wherein the peak-shaped spring portion is constructed from plastic that is manually flexible in the expanded configuration.

12. The clamp device recited in claim 6, wherein the spring portion is a partial arch, having one end of said partial arch contacting a top surface of said upper bracket, and a distal end of said arch is suspended above said top surface of said upper bracket.

13. The clamp device recited in claim 12, wherein the partial arch shaped spring portion is constructed from plastic that is manually flexible in the expanded configuration.

14. The clamp device recited in claim 12, wherein the spring is coupled to one of said fasteners.

15. The clamp device recited in claim 12, wherein the spring is coupled to the upper bracket by a flat planar portion.

16. The clamp device recited in claim 15, wherein the flat planar portion is connected to said partial arch by a downward stepping lip portion.

17. The clamp device recited in claim 6, wherein the compressible channel insert and the necked, through-slot extension are monolithic.

18. The clamp device recited in claim 6, wherein the compressible channel insert, the necked, through-slot extension and the upper bracket are monolithic.

19. The clamp device recited in claim 6, wherein the compressible channel insert is coupled to the upper bracket midway along a length-wise axis of the upper bracket.

20. The clamp device recited in claim 6, further comprising a load bar engaging surface layer on the upper bracket opposite the compressible channel insert.

21. The clamp device recited in claim 20, wherein the load bar engaging surface layer is constructed from a different material than the upper bracket.

22. The clamp device recited in claim 21, wherein the rack engaging surface layer is constructed from a slip-resistant material that is softer than the material that constructs the upper bracket.

23.-39. (canceled)
